(19) United States
(12) Patent Application Publication
(10) Pub. No.: US 2008/0274036 A1
(43) Pub. Date: Nov. 6, 2008

(54) MICROSTRUCTURED CATALYSTS AND METHODS OF USE FOR PRODUCING CARBON NANOTUBES

(76) Inventors: Daniel E. Resasco, Norman, OK (US); Yongqiang Tan, Norman, OK (US)

Correspondence Address: DUNLAP CODDING, P.C., PO BOX 16370, OKLAHOMA CITY, OK, 73113, US

(21) Appl. No.: 12/111,617

(22) Filed: Apr. 29, 2008

Related U.S. Application Data
(63) Continuation-in-part of application No. 11/450,642, filed on Jun. 9, 2006.
(60) Provisional application No. 60/694,545, filed on Jun. 28, 2005.

(51) Int. Cl. D01F 9/12; B01J 31/06; B05D 3/10

(52) U.S. Cl. 423/447.2; 427/387; 502/159; 423/447.1; 502/158; 977/751

(57) ABSTRACT

Methods for producing microstructured catalytic substrates and microstructured catalytic substrates produced by the methods, and methods for growing single-walled carbon nanotubes on the microstructured catalytic substrates wherein the single-walled carbon nanotubes are preferably of a highly specific chirality.

### CROSS-REFERENCE TO RELATED APPLICATIONS

The present application is a continuation-in-part of U.S. Ser. No. 11/450,642, filed Jun. 9, 2006, which claims the benefit of U.S. Provisional Application Ser. No. 60/694,545, filed Jun. 28, 2005, in accordance with 35 U.S.C. § 119(e), each of which is hereby expressly incorporated herein by reference in its entirety.

### BACKGROUND OF THE INVENTION

This invention is related to the field of catalysts and methods for producing carbon nanotubes and methods of their use, and more particularly, but not by way of limitation, to catalysts and methods for producing (“growing”) single-walled carbon nanotubes of highly specific (m,m) structure.

Carbon nanotubes (CNTs) are seamless tubes of graphene sheets with full fullerene caps which were first discovered as multi-layer concentric tubes or multi-walled carbon nanotubes (MWNTs) and subsequently as single-walled carbon nanotubes (SWNTs). Carbon nanotubes have shown promising applications including uses in nanoscale electronic devices, such as thin film transistors, high strength materials, electron field emission, tips for scanning probe microscopy, and transparent conductors for example.

Generally, single-walled carbon nanotubes are preferred over multi-walled carbon nanotubes for use in these applications because they have fewer defects and are therefore stronger and more conductive than multi-walled carbon nanotubes of similar diameter. Defects are less likely to occur in SWNTs than in MWNTs because MWNTs can survive occasional defects by forming bridges between unsaturated carbon valances, while SWNTs have no neighboring walls to compensate for defects. Further, SWNTs often have less variability in their properties than MWNTs. SWNTs in particular exhibit exceptional chemical and physical properties that have opened a vast number of potential applications.

In general, selective growth of SWNTs has several meanings. In one case, SWNT selectivity can imply the fraction of carbon in the sample forming SWNT as opposed to other forms of carbon. The second type of selectivity relates to nanotube length, which, as recently shown, can only be controlled in some specific cases. The third and more challenging type of selectivity relates to the controlled production of specific (m,m) structures in much higher proportion than other structures (i.e., chiralities of high specificity.

One of the most useful features of SWNTs is that their electronic properties are strongly related to their diameters and orientations of the carbon hexagons that form their walls. These characteristics are uniquely specified by the chiral vector identified with the integers (m,m) Most nanotube synthetic methods result in a wide distribution of (m,m) species for example, wherein a single (m,m) structure typically comprises no more than 3-4% of the total amount of SWNTs. However, the availability of CNTs and SWNTs in particular quantities, forms and chiral specificity necessary for practical applications has been problematic, as noted above. Large scale processes for the production of high quality SWNTs of high specificity are still needed, and suitable forms of the SWNTs for application to various technologies are still needed. Since current methods of CNT production often result in the production nanotubes having a diversity of diameters and chiral angles in the same batch, the electronic, optical, and adsorptive properties of CNTs therein vary widely.

In particular, SWNTs of different (n,m) structure absorb and emit electromagnetic radiation at different wavelengths. S11 and S22 refer to the electronic transitions between occupied and unoccupied levels in semiconducting nanotubes, associated with the first (S11) and second (S22) pairs of the van Hove singularities. Semiconducting SWNTs absorb in the S11 and S22 transitions and fluoresce with S11 energy. SWNTs having (m,m) structures wherein (n-n) is divisible by 3 are metals or semimetals and do not fluoresce.

In many applications it would be desirable to have CNT compositions which not only have a high purity of SWNTs, but which are also highly specific for one or just a few particular (m,m) structures (chiralities). It is to satisfy this need that the present invention is directed.

Previous U.S. patents and applications directed to catalysts and methods of producing carbon nanotubes, including U.S. Pat. No. 6,333,016, U.S. Pat. No. 6,413,487, U.S. Published Application 2002/0165091 (U.S. Ser. No. 09/988,847), and U.S. Published Application 2003/0091496 (U.S. Ser. No. 10/118,834), and other patents or published applications cited herein, are hereby expressly incorporated by reference herein in their entireties.

### BRIEF DESCRIPTION OF THE DRAWINGS

FIG. 1 shows a preliminary stage catalytic substrate after co-precipitation of Co—Mo and polymerization of TEOS with carbon fiber still present as support material.

FIG. 2 shows the catalytic substrate of FIG. 1 after calcination at 650° C. for 3 hours. All carbon fiber support material has been removed leaving only the catalytic substrate.

FIG. 3 shows that after reaction with CO at 750° C. for 30 minutes the catalytic substrate of FIG. 2 is covered by SWNTs. This is raw “as-produced” material before removal of the catalytic substrate.

FIG. 4 is an SEM image showing SWNT product on the catalytic substrate of FIG. 3. The entire surface is covered by SWNTs which shows this catalytic substrate is effective as a high yield catalyst.

FIG. 5 is a magnified SEM image of the SWNT product of FIG. 4.

FIG. 6 shows Raman spectra taken at three different locations on the SWNT product of FIG. 3. The spectrum shows that the material produced is homogenous and has high quality and high selectivity to SWNT. The D/G band ratio (1350 cm⁻¹:D band due to disordered sp3 carbon, 1590 cm⁻¹:G band due to ordered sp2 carbon). The low frequency bands are the so-called radial breathing mode bands and are characteristic of SWNTs.

FIG. 7 shows a graph of temperature programmed oxidation (TPO) of the SWNT material of FIG. 3 shows only one peak around 570° C. which confirms that only SWNTs are produced during the reaction.

FIG. 8 shows SEM images of purified SWNTs produced on the microstructured tubular supported catalyst of FIG. 3. This shows that the SWNT material may keep the tubular structure (configuration) even after purification (removal of catalytic substrate).

FIG. 9 shows Raman spectra on three different locations of SWNTs produced on a microstructured tubular supported catalyst with only Co as the catalytic metal. The spectrum shows that the material produced has high quality and high selectivity for SWNTs.

FIG. 10 shows an SEM image of SWNTs produced on the Co—Mo catalytic substrate made without a support material. SWNTs are entangled with catalyst particles and form sponge like structures.

FIG. 11 shows a TGA graph of purified SWNTs produced on the co-precipitated Co—Mo catalyst without any support material. The peak around 467° C. is from SWNTs and small peaks at higher temperature are from catalyst residue. The only dominant carbon peak shows that only SWNTs are produced which confirms the high selectivity of the catalytic substrate.

FIG. 12 shows a TGA graph of purified SWNTs produced on a Co—Mo catalyst prepared by impregnation method. The peak around 500° C. is from SWNTs. However, the higher temperature peak around 586° C. is from other forms carbon. The different carbon peaks shows the selectivity of this catalyst is substantially less than the co-precipitated Co—Mo catalyst.

FIG. 13 is a Raman spectrum of SWNTs produced at 650° C. on a Co—Mo catalyst with colloidal silica as support material. The Radial breathing mode bands show that SWNTs with smaller diameters are produced.

FIG. 14 is a Raman spectrum of SWNTs produced at 700° C. on the Co—Mo catalyst of FIG. 13. The Radial breathing mode bands show that SWNT diameter increases with reaction temperature.

FIG. 15 is a Raman spectrum of SWNTs produced at 750° C. on the Co—Mo catalyst of FIG. 13. The Radial breathing mode bands show that SWNT diameter increases with reaction temperature.

FIG. 16 is a Raman graph of SWNTs produced at 800° C. on the Co—Mo catalyst of FIG. 13. The Radial breathing mode bands show that SWNT diameter increases with reaction temperature.

FIG. 17 is a Raman graph of SWNTs produced at 850° C. on the Co—Mo catalyst of FIG. 13. The Radial breathing mode bands show that SWNT diameter increases with reaction temperature.

FIG. 18 is a Raman graph of SWNTs produced at 900° C. on the Co—Mo catalyst of FIG. 13. The Radial breathing mode bands show that SWNT diameter increases with reaction temperature.

FIG. 19 shows an Optical Absorption graph of the SWNT products of FIGS. 13-18 at different reaction temperatures (650° C.-900° C.). The observed bands are the electronic transitions corresponding to semiconducting SWNTs present in the sample. The range of nanotubes diameter corresponding to these nanotubes is approximately 0.8 to 1.0 nm. The dominant nanotubes species is (6,5) at 650° C. and changes to (7,6) at 750° C.

FIG. 20 is an Optical Absorption graph of the SWNT product in the example corresponding to polymerization of TEOS+Co—Mo on colloidal silica (Ludox). The observed bands are the electronic transitions corresponding to semiconducting SWNTs present in the sample. The range of nanotubes diameter corresponding to these nanotubes is 0.8 to 1.0 nm. The dominant nanotubes species is (7,6) followed by (8,7), with quantities of (6,5), (7,5) and (8,6).

FIG. 21 is a Raman spectrum of the product from FIG. 20 corresponding to polymerization of TEOS+Co—Mo on colloidal silica (Ludox). The spectrum shows that the material produced has high quality and high selectivity to SWNTs.

FIG. 22 is an Optical Absorption graph of the SWNT product in the example corresponding to polymerization of TEOS+Co—Mo on precipitated silica (HiSil). The observed bands are the electronic transitions corresponding to semiconducting SWNTs present in the sample. The range of nanotubes diameter corresponding to these nanotubes is 0.8 to 1.0 nm. The dominant nanotubes species is (7,6) followed by (8,7), with quantities of (6,5) and (7,5).

FIG. 23 shows a Raman spectrum of the product from the example corresponding to polymerization of TEOS+Co—Mo on precipitated silica (HiSil). The spectrum shows that the material produced has high quality and high selectivity to SWNTs.

FIG. 24 shows a Raman spectrum of the product from the example corresponding to polymerization of TEOS+Co—Mo on a flat surface. The spectrum shows that the material produced has high quality and high selectivity to SWNTs.

FIG. 25 is an SEM image of the SWNT product obtained on the catalysts produced by polymerization of TEOS+Co—Mo on a flat surface.

FIG. 26 is a magnified version of the SEM image of FIG. 25.

FIG. 27 shows the effect of increasing reaction temperature on (m,m) species distribution using a microstructured catalytic substrate.

FIG. 28 shows the effects of increasing reaction temperature on carbon nanotube diameter.

### DESCRIPTION OF THE INVENTION

The present invention contemplates catalysts and methods for producing highly pure quantities of single-walled carbon nanotubes, and particularly such quantities which are highly enriched in particular SWNTs having specific (m,m) structures, i.e., which have highly specific chiralities.

More particularly, the present invention is directed to producing quantities of SWNTs highly specific for particular (nom) structure, wherein the SWNTs are grown on a microstructured catalytic substrate which is produced by mixing a catalytic metal precursor solution with a polymerizable oxide precursor solution and coating a support material with the precursor mixture, then treating the coated support material with a polymerization catalyst so as to cause polymerization of the oxide precursors into a polymeric network with the catalytic metal or metals incorporated therein to form a microstructured catalytic material (alternatively the polymerization catalyst may be added to the precursor mixture before the precursor mixture is applied to the support material). The support material may be removed, for example by combustion or dissolution such that the microstructured catalytic material alone comprises the microstructured catalytic substrate, or the support material may remain associated with the catalytic material such that the microstructured catalytic material and the support material together comprise the microstructured catalytic substrate.

The SWNT compositions produced herein can be used for any number of purposes which employ CNTs or SWNTs in particular, but are especially favored for applications in which the optical absorptive and emitting qualities are of prime importance, for example in therapeutic and electronic applications. The CNTs and SWNTs produced herein could be used in applications such as sensors, interconnects, transistors, field emission devices, and other devices, and for purposes such as filling and strengthening components in polymers and composites and for therapies which would benefit from CNTs with specific optical and electronic properties.

Materials contemplated herein for use as support materials for catalyst deposition include or may be constructed from (but are not limited to): wafers and sheets of SiO₂, Si, silica particles, silica nanoparticles colloidal silica, oxide particles, organometallic silica, p- or n-doped Si wafers with or without a Si₂ layer, amorphous carbon, Si₃N₄, Al₂O₃, MgO, quartz, glass, oxidized silicon surfaces, silicon carbide, ZnO, GaAs, GaP, GaN, Ge, and InP, sheets of metal such as iron, steel, stainless steel, and molybdenum, ceramics such as alumina, magnesia and titania, and fibers and fibrous materials, constructed for example from carbon, carbohydrates, proteins (e.g., hair) or polymers. Where used herein, the term “template” preferably refers to a substrate material upon which a catalytic precursor material is applied, but which is then removed after the catalytic precursor material is processed into a catalytic material.

Polymers which may be used as support materials herein include but are not limited to: vinyl polymers such as, but not limited to, polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and 3,4-polychloroprene. Exemplary polymers also include nonvinyl polymers such as, but not limited to, poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), poly(tetramethylene-m-benzenesulfonamide). Typically, the polymer will fall within one of the following polymer classes: polyolefin, polyether (including all epoxy resins, polyacetal, polyetheretherketone, polyetherimide, and poly(phenylene oxide)), polyamide (including polyureas), polyamideimide, polyarylate, polybenzimidazole, polyester (including polycarbonates), polyurethane, polyimide, polyhydrazide, phenolic resins, polysilane, polysiloxane, polycarbodiimide, polyimine, azo polymers, polysulfide, and polysulfone.

The polymer used herein can be synthetic or naturally-occurring. Particularly preferred natural polymers include polysaccharides and derivatives thereof such as cellulosic polymers (e.g., cellulose and derivatives thereof) and starch polymers. Exemplary derivatives of starch and cellulose include various esters, ethers, and graft copolymers. The polymer may be crosslinkable in the presence of a multifunctional crosslinking agent or crosslinkable upon exposure to actinic radiation. The polymer can be a homopolymer of any of the foregoing polymers, random copolymers, block copolymers, alternating copolymers, random tripolymers, block tripolymers, alternating tripolymers, derivatives thereof (e.g., graft copolymers, esters, or ethers thereof), and the like. The polymer molecular weight is not considered a limiting factor in the present invention, and the number average molecular weight will typically be in the range from about 250 to more than 100,000 Da, although any molecular weight could be used without departing from the invention.

Support materials which can be used herein to produce the catalytic substrates of the present invention also include continuous (non-particulate) surfaces which may be completely flat (planar) or may have a curvature including convex and concave surfaces, and surfaces which are irregular, or even comprise fibers or fiber mats.

The catalytic substrates used in the present invention are prepared in one embodiment by depositing a precursor mixture of a catalytic metal precursor solution and a polymerizable oxide precursor solution upon a support material, then drying and polymerizing the precursor mixture on the support material. For example, a Co/Mo metal precursor solution can be prepared by mixing cobalt nitrate and ammonium heptamolybdate (or molybdenum chloride) and adding it to an oxide precursor solution and applying the mixture to the support material. The total metal loading on the support material may be, for example, from 0.001 to 1000 mg/sq cm. After deposition of the precursor mixture thereon, the coated support material is preferably first dried in air at room temperature, then in an oven at 100° C.-120° C. for example, and finally may be calcined in flowing air at 400° C.-600° C. or may simply be exposed to a polymerization catalyst which causes polymerization of the oxide precursor.

As noted, the catalytic metal precursors of the present invention are combined with a polymerizable oxide precursor to form a precursor mixture. Polymerizable oxide precursors which may be used herein include, but not limited to, silicates, silanes, and organosilanes, including polysiloxanes, polycarbosilanes, organosilazanes, polysilazanes, alkoxide-derived siloxanes, alkyl-cyclosiloxanes, alkyl-alkoxy-silanes, poly-alkyl-siloxanes, amino-alkyl-alkoxy-silanes, and alkyl-orthosilicates (e.g., tetraethylorthosilicate-TEOS). Other oxide precursors include, but are not limited to organotitanates, such as titanium alkoxides or titanoxanes; organic aluminoxy compounds, organozirconates, and organomagnesium compounds (e.g., Mg alkoxide).

Solvents which may be used to dissolve the catalytic metal precursors to make the catalytic metal precursor solutions include, but are not limited to, methanol, ethanol, isopropanol, other alcohols, acetone, other organic solvents, acids, and water, depending on the solubility of the metal precursors and nature of the polymerizable oxide precursor that the catalytic metal precursor is mixed with.

Carbon nanotubes can be produced on these catalytic substrates in different reactors known in the art such as packed bed reactors, fixed bed reactors, spouted bed reactors, structured catalytic reactors, fluidized-bed reactors, static boat-type crucibles, or moving bed (transport) reactors (e.g., having the catalytic substrates carried on a conveying mechanism such as in the systems described for example in more detail in U.S. Ser. No. 11/450,652).

The catalytic substrates may optionally be pre-reduced (e.g., by exposure to H₂ at an elevated temperature for example, at a temperature up to or exceeding the reaction temperature) before the catalytic substrate is exposed to reaction conditions and the carbon-containing gas. Alternatively, H₂ gas may be supplied with the carbon containing gas wherein reduction occurs concurrently with exposure to the carbon-containing gas. Alternatively, the catalytic substrate may not be pre-reduced prior to exposure to the carbon-containing gas. Prior to exposure to the carbon containing gas (e.g., CO or others such as described herein), the catalytic substrate is preferably heated in an inert gas (e.g., He) up to or above the reaction temperature. Subsequently, a heated carbon-containing gas (e.g., CO) or gasified liquid (e.g., ethanol) is introduced. After a given reaction period ranging preferably from 1 to 600 min, the catalytic substrate, after having SWNTs grown thereon, is cooled down to a lower temperature such as room temperature and may be exposed to further treatment conditions, for example to remove the SWNTs from the catalytic substrate.

For a continuous or semi-continuous system, the pretreatment of the catalytic substrate may be done in a separate reactor, for example, for pretreatment of much larger amounts of catalytic substrate whereby the catalytic substrate can be stored for later use in the carbon nanotube production unit.

The catalytic metal precursor solutions used in forming the catalytic substrates of the present invention preferably comprise at least one metal from Group VIII, Group VIb, Group Vb, or rhenium and preferably comprise mixtures thereof having at least one metal from two different groups, most preferably one from Group VIII and one from Group VIb. For example, the catalytic composition solutions may comprise at least one of rhenium (Re), a Group VIb metal, or a Group Vb metal, and at least one Group VIII metal such as Co, Ni, Ru, Rh, Pd, Ir, Fe and/or Pt.

When the metal precursor solution is bimetallic and comprises a Group VIII metal, the solution may comprise for example any one of Co—Mo, Co—W, Co—Cr, Co—Nb, Co—Re, Ni—Mo, Ni—W, Ni—Cr, Ni—Nb, Ni—Re, Ru—Mo, Ru—W, Ru—Cr, Ru—Nb, Ru—Re, Rh—Mo, Rh—W, Rh—Cr, Rh—Nb, Rh—Re, Pd—Mo, Pd—W, Pd—Cr, Pd—Nb, Pd—Re, Ir—Mo Ir—W, Ir—Cr, Ir—Nb, Ir—Re, Fe—Mo, Fe—W, Fe—Cr, Fe—Nb, Fe—Re, Pt—Mo, Pt—W, Pt—Cr, Pt—Nb, or Pt—Re. In a particularly preferred embodiment the catalytic metal precursor solutions comprise a Co precursor and a Mo precursor.

When more than one metal precursor is present, the ratio of each metal, e.g., the ratio of the Group VIII metal to the Group VIb metal and/or Re and/or Group Vb metal in the catalytic substrate, may affect the yield, and/or the selective production of SWNTs as noted elsewhere herein. When a Group VIII and one other Group VIb, Group Vb, or Re metal precursor is present, the molar ratio of the Group VIII metal to the Group VIb, Group Vb or Re metal is preferably from about 1:20 to about 20:1; more preferably about 1:10 to about 10:1; still more preferably from 1:5 to about 5:1; and further including 1:9, 1:8, 1:7, 1:6, 1:5, 1:4, 1:3, 1:2, 1:1, 2:1, 3:1, 4:1, 5:1, 6:1, 7:1, 8:1, and 9:1, and ratios inclusive therein. Generally, when Re is used, the concentration of the Re metal exceeds the concentration of the Group VIII metal (e.g., Co) or other metal in catalytic precursor solutions and catalytic metal substrates employed for the selective production of SWNTs.

Where used herein, the phrase “an effective amount of a carbon-containing gas” means a gaseous carbon species (which may have been liquid before heating to the reaction temperature) present in sufficient amounts to result in deposition of carbon on the catalytic substrates at elevated temperatures, such as those described herein, resulting in formation of SWNTs thereon.

Examples of suitable carbon-containing gases and gasified liquids which may be used herein include, but are not limited to, aliphatic hydrocarbons, both saturated and unsaturated, such as methane, ethane, propane, propene, butane, hexane, ethylene, and propylene; carbon monoxide; oxygenated hydrocarbons such as ketones, aldehydes, and alcohols such as ethanol, propanol, isopropanol, methanol; aromatic hydrocarbons such as toluene, benzene and naphthalene; and mixtures of the above, for example carbon monoxide and methane. The carbon-containing gas may optionally be mixed with a diluent gas such as helium, argon or hydrogen or gasified liquid such as water vapor.

The preferred reaction temperatures for use with the catalytic substrates are between about 600° C. and 1200° C.; more preferably between about 650° C. and 1000° C.; and most preferably between 750° C. and 950° C.

In one embodiment, SWNTs comprise at least 50% of the total CNT product produced on the catalytic substrates. Furthermore, SWNTs may comprise 60%, 65%, 70%, 75%, 80%, 85%, 90%, 95%, 97.5%, 98% or 99% of the total CNT product.

In a preferred embodiment, a single (m,m) species of SWNT comprises at least 20% of the total SWNT product. Furthermore, for example, a single (m,m) species may comprise 25%, 30%, 35%, 40%, 45%, 50%, 55%, 60%, 65%, 70%, 75%, 80%, 85%, 90%, 95%, 97.5%, 98% or 99% of the SWNT product. For example, the predominant (m,m) species may be (6,5), (7,6), (8,6) or (8,7), or a combination thereof such as (6,5) and (7,6), or (7,6) and (8,7) and in various embodiments may comprise amounts of (6,5), (7,5), (7,6), (8,6), (8,7), (9,7) and/or (9,8) species for example.

In one embodiment, the catalyst substrates are produced by depositing the precursor mixture on a support material, treating the coated support material to cause polymerization of the metal oxide precursor of the mixture, then removing (e.g., by dissolution or combustion) the support material to leave an open microstructured catalytic substrate structure having a high surface area. The open microstructure of this catalytic substrate not only provides a considerable benefit in the production of SWNTs (i.e., higher yield, higher selectivity), but also provides benefits during the post-production purification process, since the open catalytic substrate is much more readily dissolvable by the acidic or alkaline species typically used to remove the catalytic substrate from the final carbon nanotube product.

In a conventional catalyst preparation (for example in the CoMoCAT™ method), the catalytic species are impregnated over a preformed support, such as silica, and simply dried or calcined. In the present method, in one embodiment, a silica precursor solution (or other metal oxide precursor solution) which comprises an organometallic compound such as an alkoxide or an organo-silane as described above is used. Depending on the preparation conditions, such as the concentration of the oxide precursor in the solution, whether or not the support material is removed, the pH of the solution, the temperature, and type of solvent (water, alcohol), and type of catalytic metal added, the oxide precursor (for example TEOS) undergoes a hydrolysis-polycondensation polymerization reaction that results in particular polymeric structures that can be described as entangled chains of silica (or other metal) nanoparticles. These chains eventually form a colloidal suspension that reaches a semi-solid condition depending on the conditions (e.g., pH, temperature, concentration). The resulting semi-solid is aged for a predetermined period of time, during which the polymeric network therein further strengthens. A base (preferably an OH⁻ donator) to increase the pH (e.g., NH₃ vapor, or NaOH, or NH₄OH solutions, or any other suitable hydroxide base) is provided which functions as a polymerization accelerator to accelerate the polymerization reaction of the oxide precursor. Other examples of bases which may be used herein as polymerization accelerators include, but are not limited to, LiOH, KOH, Ca(OH)₂, Ba(OH)₂, Mg(OH)₂, CsOH, Sr(OH)₂, RbOH, Al(OH)₃, Sn(OH)₂, Pb(OH)₂, Fe(OH)₂, Fe(OH)₃, Zn(OH)₂, NaHCO₃, and Na₃CO₃.

Incorporated within the polymeric network are the catalytic metal precursors (e.g., Co and Mo) of the precursor mixture that are catalytically active for the synthesis of SWNTs when the optimum reaction conditions are employed on the final catalytic substrate thereby produced. As noted, in one embodiment, the removal of the support material greatly affects the pore structure of the ultimate catalytic substrate and can have a dramatic effect on SWNT yield, quality and specificity.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention. Thus, the following examples, will serve to illustrate the practice of this invention, it being understood that the particulars shown are by way of example and for purposes of illustrative discussion of preferred embodiments of the present invention only.

### EXAMPLE 1

Preparation of a Microstructured Tubular Catalytic Substrate. Cobalt (Co(NO₃)₂.6H₂O) and Molybdenum (MOCl₅) salts were dissolved in 29 ml isopropanol/water mixture at a Co:Mo molar ratio of 1:3 to form a catalytic metal precursor solution. Then, 0.5 g of carbon fiber support material with average diameter ˜10 μm was added to the solution to make the total metal loading about 3 wt. %. After that step, 0.4 mL Tetraethoxysilane (TEOS) (as the polymerizable oxide precursor) and 0.4 ml ammonium hydroxide solution (29% vol.) (as polymerization accelerator) were added to the suspension to reach a pH between 7 and 8. The system was allowed to stand for a period of 12 h during which polymerization of TEOS to silica occurred together with the precipitation of Co and Mo species within the silica polymer network.

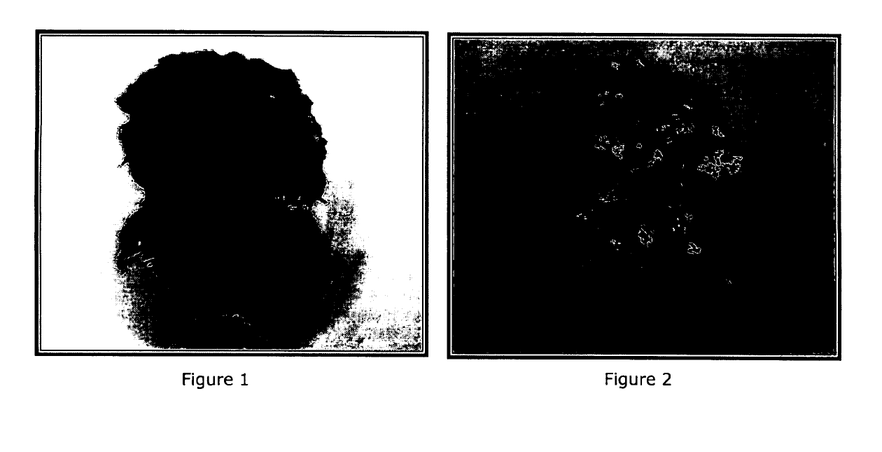

The suspension was centrifuged for 30 min. at 10,000 rpm and the supernatant liquid was discarded. A black solid sediment (FIG. 1) was collected and heated for 3 h at 650° C. to remove all the carbon fiber support material. The resulting solid product was a bluish-white open structure (the microstructured tubular catalytic substrate) that kept roughly the same texture as the pre-combusted original carbon fiber solid (see FIG. 2).

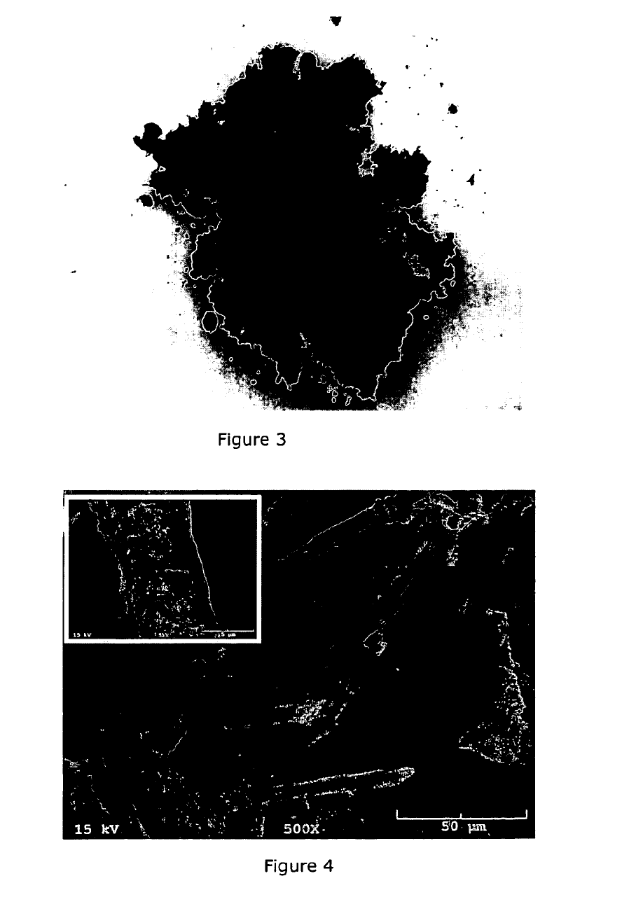

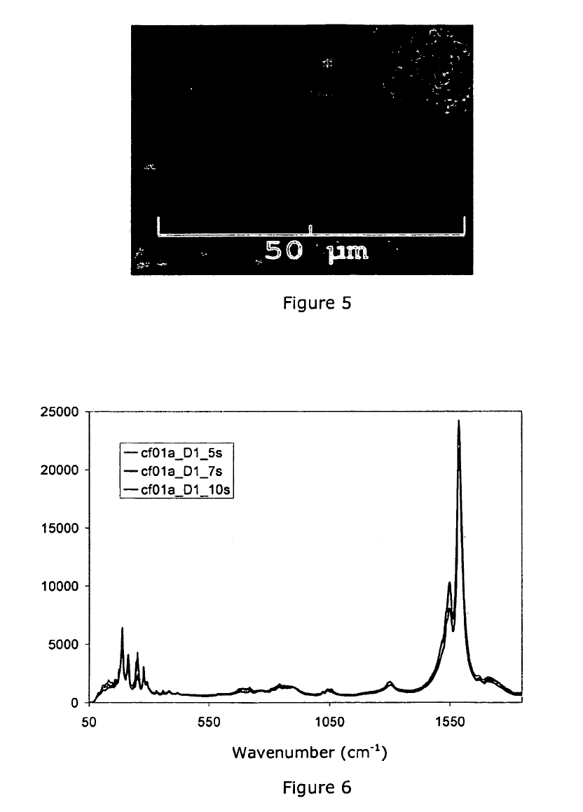

The microstructured tubular catalytic substrate was exposed to H₂ in a reduction step, then was exposed to CO gas at 700-900° C. causing growth of SWNTs thereon (FIG. 3) at high yield. SEM images (FIGS. 4 and 5) show that SWNTs were grown on the surface of the tubular silica of the catalytic substrate. The carbon content in final product is as high as 24% which is 4-5 times greater than that of a traditional CVD method to grow SWNTs (Table I).

TABLE 1

| | Mass of Catalyst | | | |
|---|---|---|---|---|
| | after calcinations | Carbon | SWNT | Raman |
| Sample | (mg) | Yield | produced (mg) | (1-D/G) |
| Example 1 | 167 | 24.0% | 40.08 | 96.5% |
| Example 3 | 1348 | 2.22% | 29.93 | 96.3% |
| Example 4 | 1132 | 0.98% | 11.10 | 93.0% |
| Example 5 | 165 | 16.2% | 26.73 | 96.7% |
| Example 6 | 168 | 15.6% | 26.21 | 97.3% |

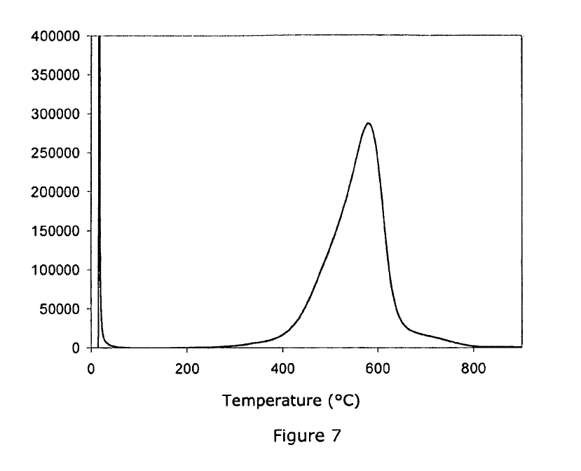

The SWNTs produced by this method were of extremely high quality. Raman analysis on different locations (FIG. 6) and TPO (FIG. 7) both show that essentially only SWNTs were synthesized and the quality is consistent in all the products.

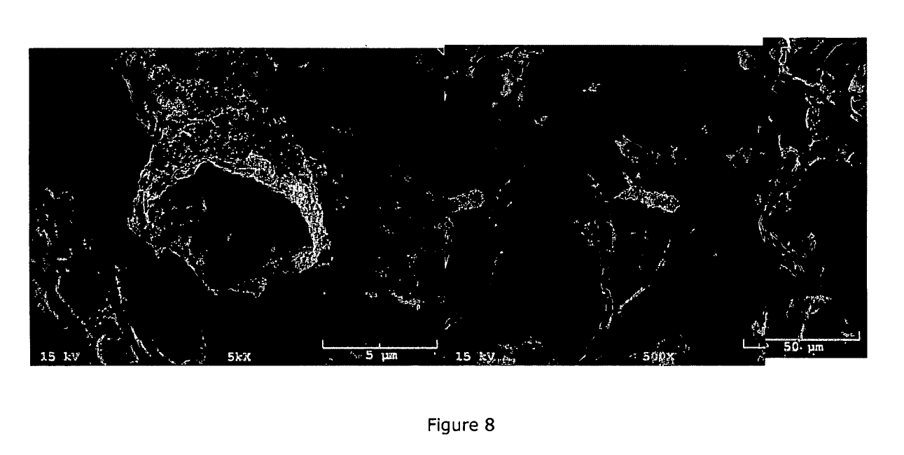

The catalytic substrate with the SWNTs thereon may be further treated to separate the support material (in this case silica) and the catalytic metals and obtain high purity SWNTs. In the case of SiO₂ as the support for example, NH₄HF₂ and HCl are able to remove the silica support material, and the catalytic metals, respectively. The SWNT mass thereby retains the tubular structure of the microstructured tubular catalytic substrate as shown in FIG. 8.

### EXAMPLE 2

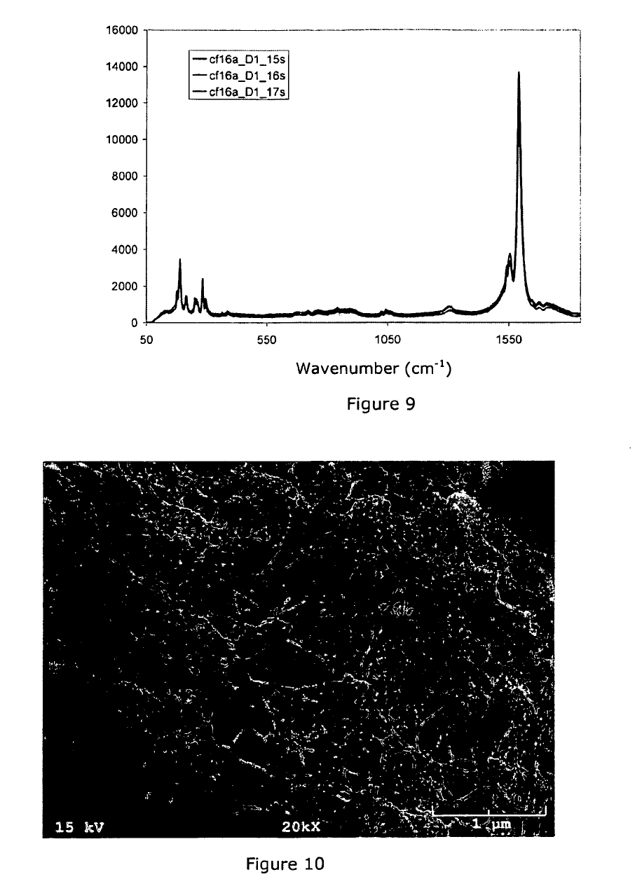

A microstructured tubular catalytic substrate was prepared using the same method as in Example 1, except only Cobalt (Co(NO₃)₂.6H₂O) salt is used. Raman spectra show that high quality SWNTs were produced using the same reaction conditions (FIG. 9).

### EXAMPLE 3

In another embodiment, 3g of Ludox colloidal silica (40% solid) were used as a support material instead of a carbon fiber and the same procedure of Example 1 was used to prepare the catalytic substrate (except the Ludox colloidal silica was left as a support material in the catalytic substrate). The same high quality SWNTs were produced (Table 1).

### EXAMPLE 4

The same procedure as Example 3 was used except no TEOS was used to prepare the catalytic substrate. SWNTs were produced using the same reaction conditions as Example 1, although yield was lower (Table 1). It is clear that a polymerizable oxide precursor, such as TEOS, is important to produce high quality SWNTs.

### EXAMPLE 5

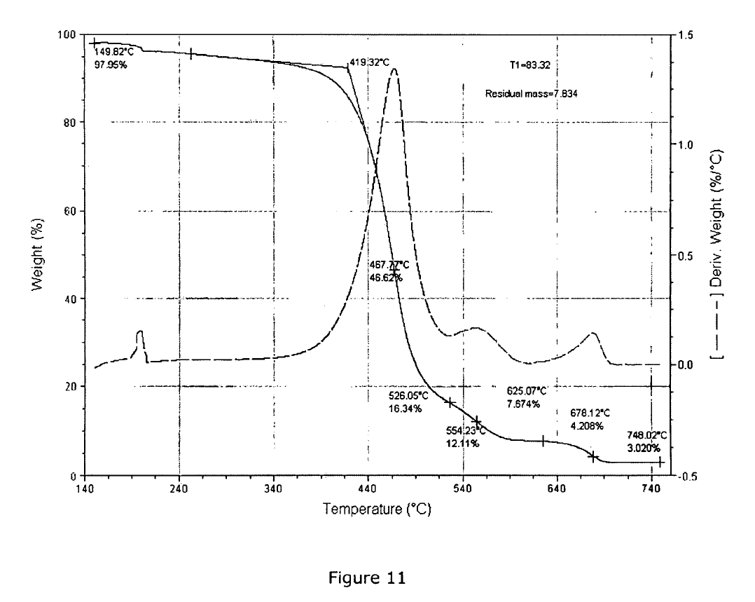

The same procedure was followed as in Example 1 except silica rather than carbon fiber is used as a support material (and is not removed). Similar high quality SWNTs (Table 1) were produced using the same reaction conditions as Example 1. The ˜16% yield is 3× that of traditional CVD method used to grow SWNTs. SEM images (FIG. 10) show that SWNTs are grown from the surface of silica particles generated from TEOS and form a 3-D network. TGA (FIG. 11) shows only one carbon peak which means essentially only SWNTs were produced. Once again, this example demonstrates that this catalytic substrate has high selectivity to SWNT.

### EXAMPLE 6

The same procedure as in Example 5 was followed except the aging time was increased to two weeks (from 12 hours) to prepare the catalytic substrate. Similar high quality SWNTs (Table 1) were produced using the same reaction conditions as Example 1. This shows that the catalytic substrate would not be affected by a long aging time.

### EXAMPLE 7

The same procedure as in Example 5 was used to prepare the catalytic material, but in place of using H₂ as a reduction gas, CO was used as the only feeding gas in entire reaction. High quality SWNTs (similar to those of Example 5) were produced. The yield is similar as reaction using H₂ as a reductant. However, the elimination of the step of exposure of the catalytic substrate to H₂ or HeN₂ reduces the reaction time to as short as 1.5 hours, which is 50-100 minutes less than a standard CoMoCat method.

### EXAMPLE 8

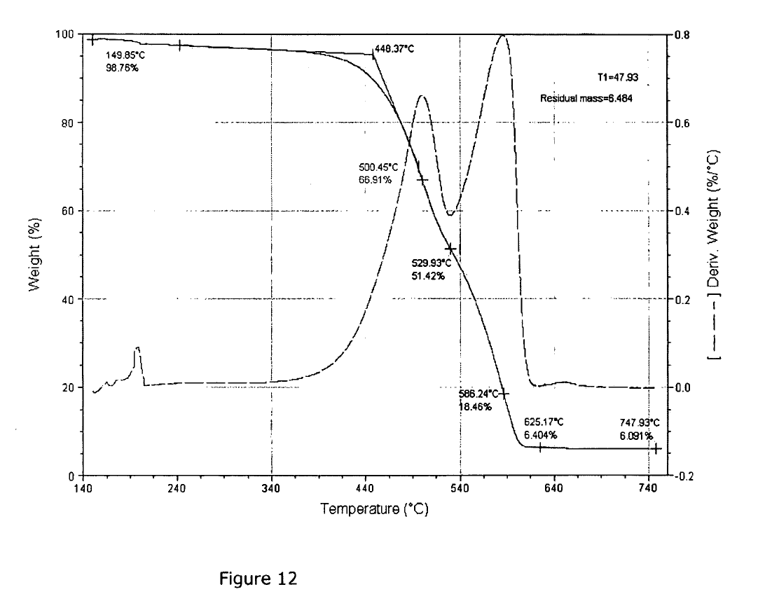

The same procedure as in Example 3 was used to prepare the catalytic substrate. In this example, CO was used as the only feeding gas in the entire reaction. During reaction program, the temperature of the catalytic substrate was increased to the reaction temperature (e.g., 750° C. in this case) over 30 minutes, then CO gas flow was maintained for 1 hour at the reaction temperature. In this case, the feed gas/catalyst ratio was 0.1 L/min/g·cat which is 5-10 times less than the standard CoMoCat process. High quality SWNTs (as seen from Raman analysis) were produced by this reaction (see Example 9 below). To compare, a CoMo catalyst prepared by a conventional impregnation method (i.e., the CoMoCat method) was tested at 0.4 L/min/g·cat CO/catalyst ratio, FIG. 12 shows the TGA of the SWNTs produced by the CoMoCat method. It is clear that two different forms of carbon were produced by the conventional method. This example also demonstrates that a coprecipitation catalyst (as contemplated for use in the present invention) has advantages over other catalysts.

### EXAMPLE 9

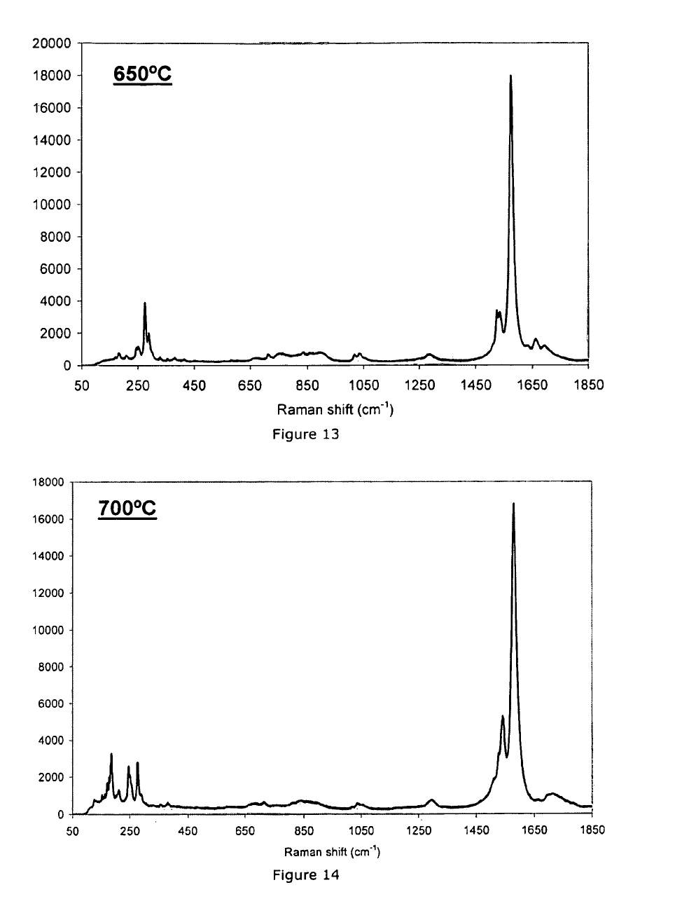

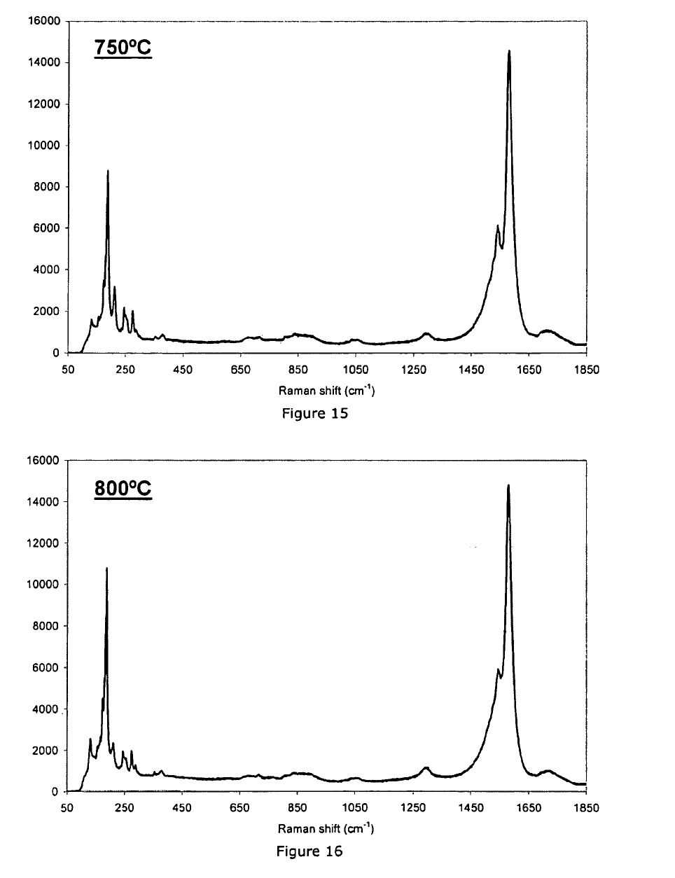

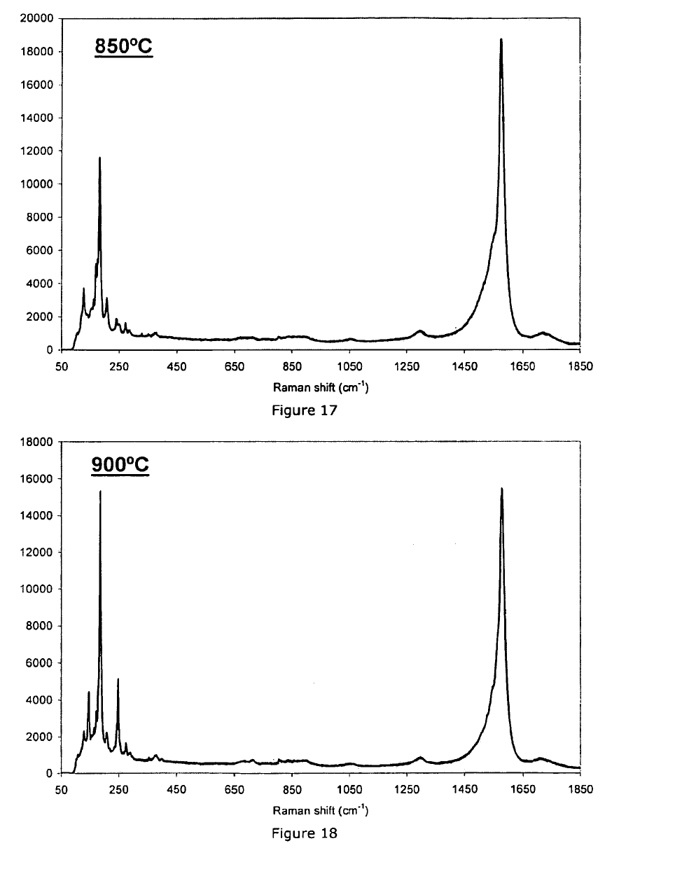

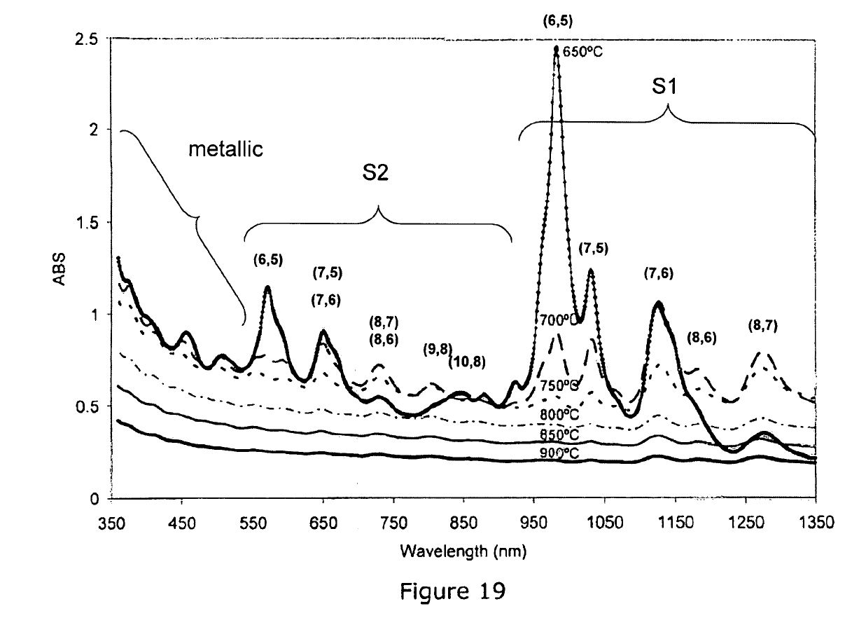

The same procedure used in Example 8 was used to prepare the catalytic substrate. The reaction was then run at different temperatures from 650° C. to 900° C. (650° C., 700° C., 750° C., 800° C., 850° C., 900° C.). High quality SWNTs with different chiralities (as seen from Raman & Optical absorption) were produced at all the tested temperatures. This shows the present microstructure catalytic substrate is robust for different temperatures (see FIGS. 13-19).

### EXAMPLE 10

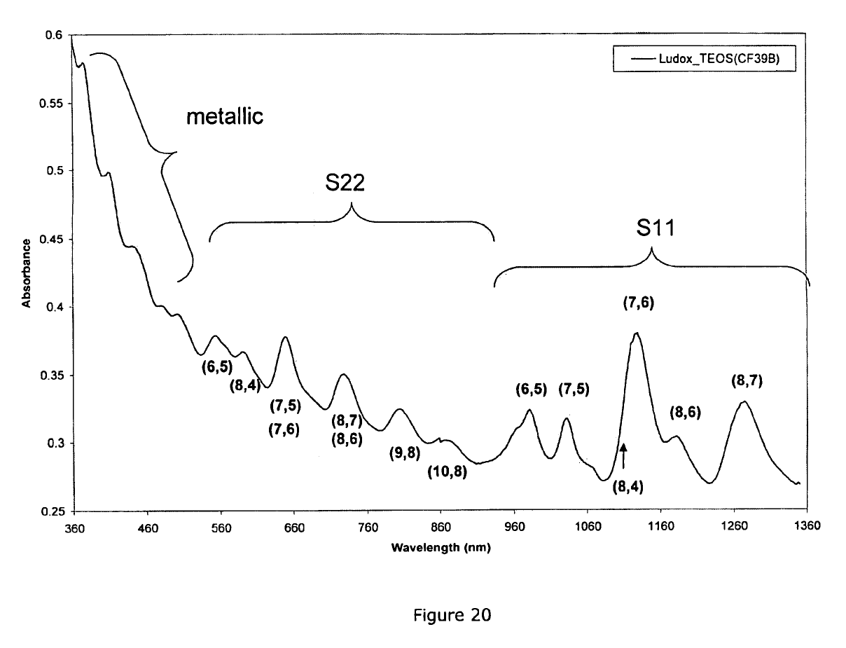

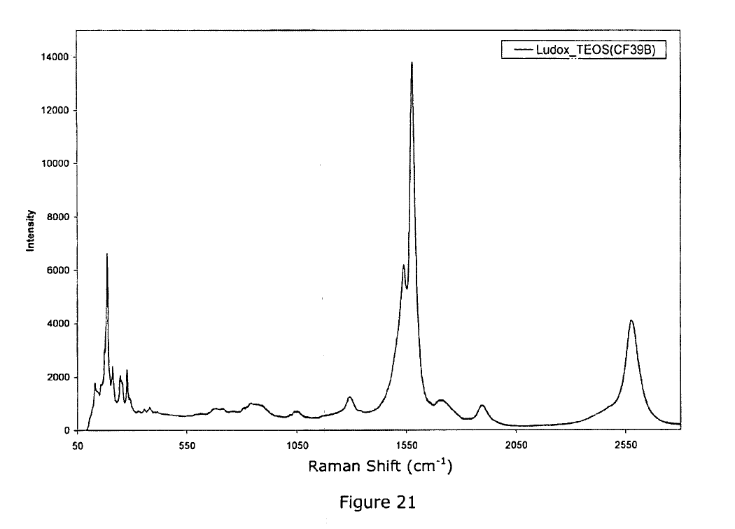

In this example, SWNTs were produced on a catalytic substrate made by polymerization of TEOS on colloidal silica (Ludox) as support material. To form the catalytic substrate, the metal loading was 2% of Co—Mo on the silica support and the ratio (in weight) of TEOS:colloidal silica used was 1:3. The catalytic metal precursors used were Co(NO₃)₂.6H₂O (Sigma Aldrich) and MoCl₅ (Sigma Aldrich). The silica support was prepared by the co-precipitation polymerization process as that used in the Example 1 but with colloidal silica as a support material instead of carbon fibers. The cobalt precursor was dissolved in deionized water and the molybdenum precursor was dissolved in isopropanol. Then, both solutions were mixed with TEOS to make a catalytic metal precursor/polymerizable oxide precursor mixture. Finally, a colloidal silica-ammonia solution (ammonia serving as the polymerization catalyst) was added to this precursor mixture (i.e., precursor mixture). After 24 hours of gelation, the gel was filtered and the remaining isopropanol was dried at 200° C. for 30 minutes. Calcination was done at 650° C. for 150 minutes to produce the final catalytic substrate. SWNTs were grown on the catalytic substrate at 750° C. under atmospheric pressure by CO disproportionation for 30 minutes. The Optical Absorption of the product (FIG. 20) shows high selectivity for SWNTs, in particular for SWNTs with a (7,6) (m,m) structure and lesser amounts of (8,7), (6,5), (7,5), (8,6) and (8,4). The Raman structure of the product (FIG. 21) shows that the CNT material produced has high quality and selectivity for SWNT.

### EXAMPLE 11

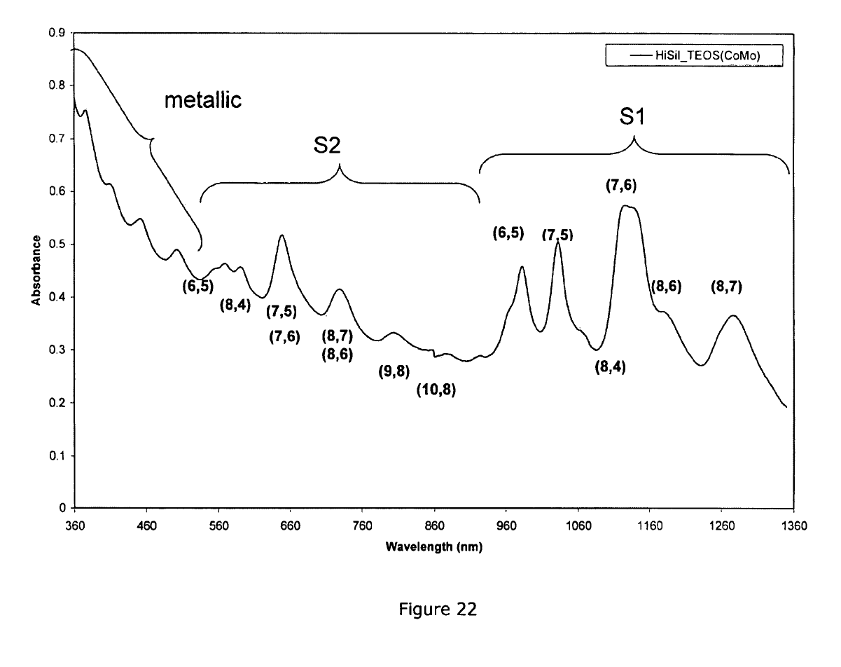

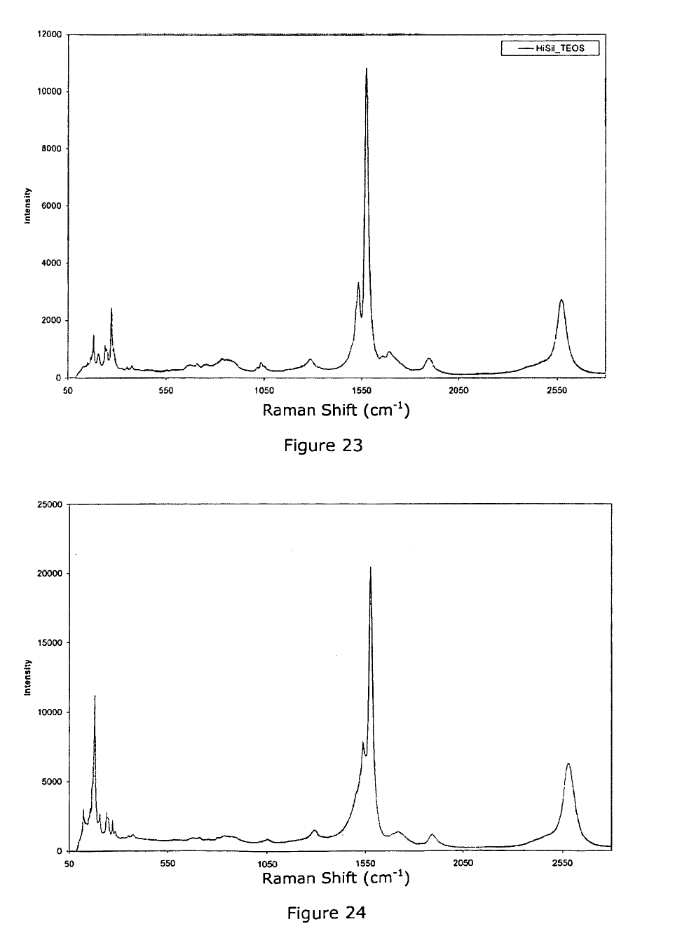

SWNTs were produced on a catalytic substrate made by polymerization of TEOS on amorphous silica (HiSil) (as support material). The metal loading was 2% of CoMo on the amorphous silica. To form the catalytic substrate, the metal precursors used were Co(NO₃)₂.6H₂O (Sigma Aldrich) and MoCl₅ (Sigma Aldrich). The cobalt precursor (16.8 mg) was dissolved in deionized water (0.5 ml) and the molybdenum precursor (47.3 mg) was dissolved in isopropanol (1.1 ml). Both solutions were mixed with TEOS (0.6 ml) to form a catalytic metal precursor/oxide precursor mixture (i.e., precursor mixture). Then, the amorphous silica (1 g) was impregnated (coated) with the metal precursor/oxide precursor mixture. Finally, the polymerization of TEOS (the oxide precursor) was performed by exposure of the impregnated (coated) silica to ammonia vapor (polymerization catalyst) for 24 hr. The material was calcined for 12 hr at 100° C. and 150 minutes at 650° C. Using the resulting catalytic substrate, SWNTs were grown at 750° C. under atmospheric pressure by CO disproportionation for 30 minutes. The Optical Absorption of the product (FIG. 22) shows high selectivity for SWNTs, primarily for (7,6) but also for (8,7) and lesser amounts of (6,5), (7,5) and (8,6). The Raman spectrum of the product (FIG. 23) shows high selectivity for SWNTs and high quality.

### EXAMPLE 12

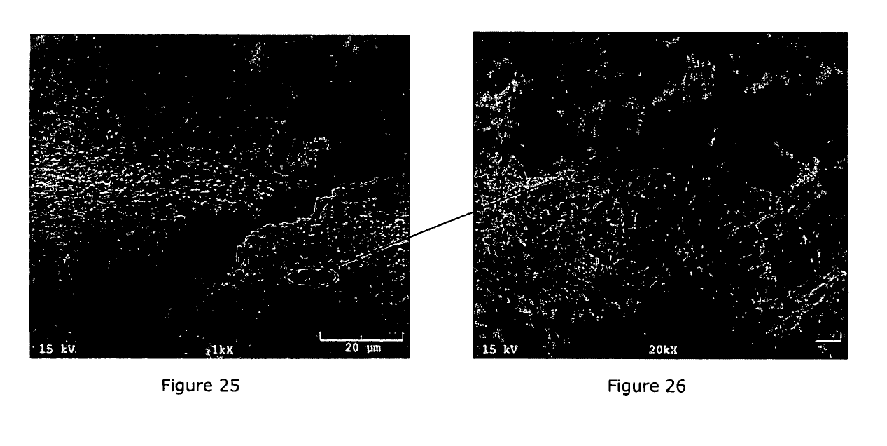

In this example, catalytic substrates were produced by polymerization of TEOS on flat surfaces (e.g., silicon wafer, stainless steel, graphite, copper). In one embodiment the metal loading was 9% of CoMo/SiO₂. The metal precursors used were Co(NO₃)₂.6H₂O (Sigma Aldrich) and MoCl₅ (Sigma Aldrich). The catalytic substrate was prepared by the co-precipitation polymerization process as in Example 1 but with a flat surface as a support material. The cobalt metal precursor was dissolved in deionized water and the molybdenum metal precursor was dissolved in isopropanol. Both solutions were mixed with TEOS to form a catalytic metal precursor/polymerizable oxide precursor mixture (i.e., precursor mixture) which was applied to a flat silicon wafer as the support material. Polymerization of TEOS was done exposing the wet surface coating to ammonia vapor for 24 hr. The coated polymerized material was calcined for 30 minutes at 200° C. and 150 minutes at 550° C. Using the resulting catalytic substrate, SWNTs were grown at 750° C. under atmospheric pressure by CO disproportionation for 30 minutes. The Raman spectrum of the nanotube product (FIG. 24) shows high quality and high selectivity for SWNTs. SEM pictures (FIGS. 25 and 26) show that the SWNTs are completely clean of silicaceous/metallic catalyst particles and that they grow from the surface forming 3-D networks.

### EXAMPLE 13

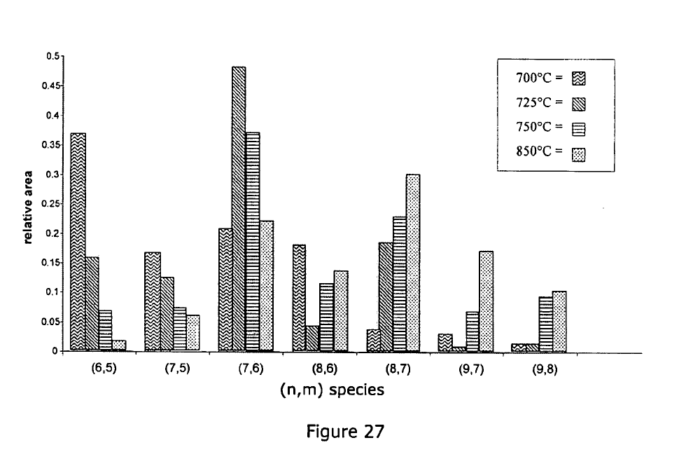

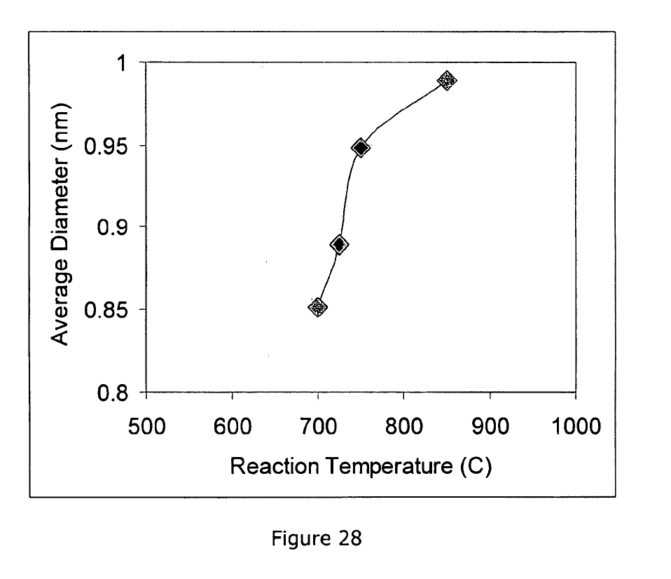

In this example, the effect of reaction temperature on (m,m) distribution on CoMo/SiO₂ catalytic substrate (prepared with TEOS polymerization) was studied. As shown in FIG. 27, as reaction temperature increased from 700° C. to 850° C., the dominant (m,m) species shifted from (6,5) to (7,6) to (8,7), with varying amounts of (6,5), (7,5), (7,6), (8,6), (8,7), (9,7) and (9,8) present at all temperatures. Further, as temperature increased from 700° C. to 850° C., the average SWNT diameter increased from about 0.85 nm to about 1.0 nm (FIG. 28).

In embodiments wherein the catalytic metal precursor/polymerizable oxide precursor mixture may be applied to flat support material, the support material may be disposed on a movable support system and the mixture applied via spraying, coating, spin coating, dipping, screen printing, or other methods known in the art. Also, the drying process can be done slowly, by letting the coated flat support material rest at room temperature and covered to keep a higher relative humidity and lower air circulation than in open air.

SWNTs grown on such flat catalytic substrates may be removed by applying a polymeric material thereto which adheres to the SWNTs then removing the polymeric material with the SWNTs adhered thereto. Examples of polymers which may be applied to the flat catalytic substrate having SWNTs thereon include, but are not limited to: polypropylene, polyethylene, polyacrylamide, polycarbonate, polyethylene terephthalate (PET), polyvinylchloride, polystyrene, polyurethane, Teflon, Saran, polyacrylonitrile, polyvinylacetate, polyvinylalcohol, polymethyl methacrylate (PMMA), polyacrylates, polyguargum, polyesters, and polyamides such as nylon, as well as polymers formed in situ for example by crosslinking pre-polymers applied to the nanotube-bearing catalytic substrate.

Similarly, the adhering and transferring medium could be a metal instead of a polymer. In this case, a metal film could be applied over the CNTs by different methods, such as sputtering or evaporation. The metal film could subsequently be welded to another metal to make electrical contacts, change surface properties, change heat conduction, and fluid dynamic properties, for example. The SWNTs can be transferred from the flat catalytic substrate by methods described in U.S. Ser. No. 11/450,642, for example.

Without wishing to be bound by theory, it is believed that the microstructured catalyst materials described herein have advantages over other catalytic materials in that they help to overcome the “hindrance” effect which typically limits the growth of SWNTs on catalytic surfaces. The question of what determines nanotube length during nanotube growth has remained unanswered for many years. The most commonly proposed explanation is that termination of growth is due to catalyst deactivation. We believe that, in addition to catalyst deactivation, another form of growth termination is related to steric hindrance. That is, as carbon accumulates by increasing length and number of SWNTs in a sample, physical hindrance for the free displacement of the growing nanotubes occurs. This mechanical restriction of the growing nanotube makes the insertion of new carbon atoms at the nanotube-metal interface more difficult. Therefore, the growth rate becomes lower and it eventually stops.

The magnitude of this hindrance is a function not only of the length and number of SWNTs, but also of the nature of the surrounding environment at the growing site. That is, the interaction of growing SWNTs with the catalyst support and/or with other nanotubes may vary depending on the pore size of the catalyst, the metal content, etc. The larger the volume of nanotubes compared to the available space, the more restricted will be the insertion of new carbon atoms at the interface. In fact, there have been several examples in which individual SWNTs have been allowed to grow practically free of interaction with the catalyst surface or other nanotubes, for example, wherein SWNTs in the 1-2 cm range were grown when the catalyst was deposited on an edge by photolithography and the growing SWNTs were suspended in the flowing gas, thus avoiding hindrance of growth by interaction with other nanotubes or the substrate surface. The authors called this phenomenon “kite-mechanism” to illustrate the growth of a long nanotube tail, aligned in the direction of the flow. Other examples of long SWNTs have been observed when the substrate is flat and the growing end is open. By contrast, when the growth is conducted on a typical high-surface-area porous catalyst, the growth process is eventually impeded by the lack of space for displacement.

Therefore, producing catalysts with a more open structure as described herein results in less hindrance for nanotube growth. Consequently, one may expect longer nanotubes and higher nanotube yields with structured catalysts that minimize geometric hindrance.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, compositions of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

All U.S. or foreign patents or published application or articles cited herein are expressly incorporated herein by reference in their entireties.

What is claimed is:

1. A method of producing a microstructured catalytic substrate for producing single-walled carbon nanotubes, comprising:
providing a support material;
applying a catalytic metal precursor-polymerizable oxide precursor mixture to the support material, wherein the catalytic metal precursor-polymerizable oxide precursor mixture comprises one or more catalytic metal precursors and one or more polymerizable oxide precursors; and
causing a polymerization reaction in the polymerizable oxide precursor to form a polymer network on the support material, wherein the polymerization reaction of the polymerizable oxide precursor is accelerated via a polymerization accelerator and as the polymer network is formed, the catalytic metal precursors become distributed within the polymer network thereby forming a microstructured catalytic polymer network on the support material thereby forming the microstructured catalytic substrate.

2. The method of claim 1 wherein the catalytic metal precursor comprises a metal selected from the group of Group VIII metals, Group VIb metals, Group Vb metals or Re.

3. The method of claim 1 wherein the support material is at least one of: wafers and sheets of SiO₂, Si, silica particles, silica nanoparticles, colloidal silica, oxide particles, organometallic silica, p- or n-doped Si wafers with or without a Si₂ layer, amorphous carbon, Si₃N₄, Al₂O₃, MgO, quartz, glass, oxidized silicon surfaces, silicon carbide, ZnO, GaAs, GaP, GaN, Ge, and InP, sheets of metal comprising iron, steel, stainless steel, and/or molybdenum, ceramics comprising alumina, magnesia and/or titania, and fibers and fibrous materials comprising carbon, carbohydrates, proteins, and/or hair, polymers comprising polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and/or 3,4-polychloroprene, nonvinyl polymers comprising poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), and/or poly(tetramethylene-m-benzenesulfonamide) polyolefin, polyethers comprising epoxy resins, polyacetal, polyetheretherketone, polyetherimide, and/or poly(phenylene oxide), polyamides comprising polyureas, polyamideimide, polyarylate, and/or polybenzimidazole, polyesters comprising polycarbonates, polyurethane, polyimide, polyhydrazide, phenolic resins, polysilane, polysiloxane, polycarbodiimide, polyimine, azo polymers, and/or polysulfide, and polysulfone, polysaccharides, cellulosic polymers, starch, derivatives of starch and cellulose, homopolymers and/or copolymers.

4. The method of claim 1 wherein the polymerizable oxide precursor is selected from the group of silicates, silanes, and organosilanes, including polysiloxanes, polycarbosilanes, organosilazanes, polysilazanes, alkoxide-derived siloxanes, alkyl-cyclosiloxanes, alkyl-alkoxy-silanes, poly-alkyl-siloxanes, amino-alkyl-alkoxy-silanes, and alkyl-orthosilicates, tetraethylorthosilicate, organotitanates, organic aluminoxy compounds, organozirconates, and organomagnesium compounds.

5. The method of claim 1 wherein the catalytic metal precursor comprises a metal selected from Co, Ni, Ru, Rh, Pd, Ir, Fe, Pt, Mo, W, Cr, Nb, and Re.

6. The method of claim 1 wherein the catalytic metal precursor is bimetallic and comprises Co—Mo, Co—W, Co—Cr, Co—Nb, Co—Re, Ni—Mo, Ni—W, Ni—Cr, Ni—Nb, Ni—Re, Ru—Mo, Ru—W, Ru—Cr, Ru—Nb, Ru—Re, Rh—Mo, Rh—W, Rh—Cr, Rh—Nb, Rh—Re, Pd—Mo, Pd—W, Pd—Cr, Pd—Nb, Pd—Re, Ir—Mo Ir—W, Ir—Cr, Ir—Nb, Ir—Re, Fe—Mo, Fe—W, Fe—Cr, Fe—Nb, Fe—Re, Pt—Mo, Pt—W, Pt—Cr, Pt—Nb, or Pt—Re.

7. The method of claim 1 wherein the polymerization accelerator is mixed with the catalytic metal precursor-polymerizable oxide precursor mixture before the application thereof to the support material.

8. The method of claim 1 wherein the polymerization accelerator is exposed to the catalytic metal precursor-polymerizable oxide precursor mixture after the application thereof to the support material.

9. A microstructured catalytic substrate produced by the method of claim 1.

10. A method of producing single-walled carbon nanotubes of high chiral specificity, comprising:
providing a microstructured catalytic substrate, wherein the microstructured catalytic substrate is produced by a method comprising:
applying a catalytic metal precursor-polymerizable oxide precursor mixture to a support material, the catalytic metal precursor-polymerizable oxide precursor mixture comprising one or more catalytic metal precursors and one or more polymerizable oxide precursors; and
causing a polymerization reaction in the polymerizable oxide precursor to form a polymer network on the support material, wherein the polymerization reaction of the polymerizable oxide precursor is accelerated via a polymerization accelerator and as the polymer network is formed, the catalytic metal precursors become distributed within the polymer network thereby forming a microstructured catalytic polymer network on the support material thereby forming the microstructured catalytic substrate; and
exposing the catalytic substrate to a heated carbon-containing gas under reaction conditions to form single-walled carbon nanotubes on the catalytic substrate wherein single-walled carbon nanotubes having a particular (m,m) structure make up at least 20% of the single-walled carbon nanotubes grown on the catalytic microstructured substrate.

11. The method of claim 10 wherein the (m,m) structure which makes up at least 20% of the single-walled carbon nanotubes is at least one of (6,5), (7,6), (8,6) and (8,7).

12. The method of claim 10 wherein the catalytic metal precursor comprises a metal selected from the group of Group VIII metals, Group VIb metals, Group Vb metals or Re.

13. The method of claim 10 wherein the support material is at least one of: wafers and sheets of SiO₂, Si, silica particles, silica nanoparticles, colloidal silica, oxide particles, organometallic silica, p- or n-doped Si wafers with or without a Si₂ layer, amorphous carbon, Si₃N₄, Al₂O₃, MgO, quartz, glass, oxidized silicon surfaces, silicon carbide, ZnO, GaAs, GaP, GaN, Ge, and InP, sheets of metal comprising iron, steel, stainless steel, and/or molybdenum, ceramics comprising alumina, magnesia and/or titania, and fibers and fibrous materials comprising carbon, carbohydrates, proteins, and/or hair, polymers comprising polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and/or 3,4-polychloroprene, nonvinyl polymers comprising poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), and/or poly(tetramethylene-m-benzenesulfonamide) polyolefin, polyethers comprising epoxy resins, polyacetal, polyetheretherketone, polyetherimide, and/or poly(phenylene oxide), polyamides comprising polyureas, polyamideimide, polyarylate, and/or polybenzimidazole, polyesters comprising polycarbonates, polyurethane, polyimide, polyhydrazide, phenolic resins, polysilane, polysiloxane, polycarbodiimide, polyimine, azo polymers, and/or polysulfide, and polysulfone, polysaccharides, cellulosic polymers, starch, derivatives of starch and cellulose, homopolymers and/or copolymers.

14. The method of claim 10 wherein the polymerizable oxide precursor is selected from the group of silicates, silanes, and organosilanes, including polysiloxanes, polycarbosilanes, organosilazanes, polysilazanes, alkoxide-derived siloxanes, alkyl-cyclosiloxanes, alkyl-alkoxy-silanes, poly-alkyl-siloxanes, amino-alkyl-alkoxy-silanes, and alkyl-orthosilicates, tetraethylorthosilicate, organotitanates, organic aluminoxy compounds, organozirconates, and organomagnesium compounds.

15. The method of claim 10 wherein the catalytic metal precursor comprises a metal selected from Co, Ni, Ru, Rh, Pd, Ir, Fe, Pt, Mo, W, Cr, Nb, and Re.

16. The method of claim 10 wherein the catalytic metal precursor is bimetallic and comprises Co—Mo, Co—W, Co—Cr, Co—Nb, Co—Re, Ni—Mo, Ni—W, Ni—Cr, Ni—Nb, Ni—Re, Ru—Mo, Ru—W, Ru—Cr, Ru—Nb, Ru—Re, Rh—Mo, Rh—W, Rh—Cr, Rh—Nb, Rh—Re, Pd—Mo, Pd—W, Pd—Cr, Pd—Nb, Pd—Re, Ir—Mo Ir—W, Ir—Cr, Ir—Nb, Ir—Re, Fe—Mo, Fe—W, Fe—Cr, Fe—Nb, Fe—Re, Pt—Mo, Pt—W, Pt—Cr, Pt—Nb, or Pt—Re.

17. The method of claim 10 wherein the carbon-containing gas comprises at least one of a saturated or unsaturated aliphatic hydrocarbon; carbon monoxide; an oxygenated hydrocarbon; an aromatic hydrocarbon or a mixture of any of the above.

18. The method of claim 10 wherein the polymerization accelerator is mixed with the catalytic metal precursor-polymerizable oxide precursor mixture before the application thereof to the support material.

19. The method of claim 10 wherein the polymerization accelerator is exposed to the catalytic metal precursor-polymerizable oxide precursor mixture after the application thereof to the support material.

20. A carbon nanotube product comprising a microstructured catalytic substrate and single-walled carbon nanotubes as produced by the method of claim 10.

21. A microstructured catalytic substrate able to produce single-walled carbon nanotubes of high chiral specificity, the microstructured catalytic substrate produced by the method of:
applying a catalytic metal precursor-polymerizable oxide precursor mixture to a support material, the catalytic metal precursor-polymerizable oxide precursor mixture comprising one or more catalytic metal precursors and one or more polymerizable oxide precursors; and
causing a polymerization reaction in the polymerizable oxide precursor to form a polymer network on the support material, wherein the polymerization reaction of the polymerizable oxide precursor is accelerated via a polymerization accelerator and wherein as the polymer network is formed, the catalytic metal precursors become distributed within the polymer network thereby forming a microstructured catalytic polymer network on the support material thereby forming the microstructured catalytic substrate; and
wherein the microstructured catalytic substrate yields single-walled carbon nantoubes of high chiral specificity when exposed to a carbon containing gas under reaction conditions, wherein single-walled carbon nanotubes having a particular (m,m) structure make up at least 20% of the single-walled carbon nanotubes grown on the catalytic microstructured substrate.

22. The microstructured catalytic substrate of claim 21 wherein the catalytic metal precursor precursor comprises a metal selected from the group of Group VIII metals, Group VIb metals, Group Vb metals or Re.

23. The microstructured catalytic substrate of claim 21 wherein the catalytic metal precursor comprises a metal selected from Co, Ni, Ru, Rh, Pd, Ir, Fe, Pt, Mo, W, Cr, Nb, and Re.

24. The microstructured catalytic substrate of claim 21 wherein the support material is at least one of wafers and sheets of SiO₂, Si, silica particles, silica nanoparticles, colloidal silica, oxide particles, organometallic silica, p- or n-doped Si wafers with or without a Si₂ layer, amorphous carbon, Si₃N₄, Al₂O₃, MgO, quartz, glass, oxidized silicon surfaces, silicon carbide, ZnO, GaAs, GaP, GaN, Ge, and InP, sheets of metal comprising iron, steel, stainless steel, and/or molybdenum, ceramics comprising alumina, magnesia and/or titania, and fibers and fibrous materials, comprising carbon, carbohydrates, proteins, and/or hair, polymers comprising polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and/or 3,4-polychloroprene, nonvinyl polymers comprising poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), and/or poly(tetramethylene-m-benzenesulfonamide) polyolefin, polyethers comprising epoxy resins, polyacetal, polyetheretherketone, polyetherimide, and/or poly(phenylene oxide), polyamides comprising polyureas, polyamideimide, polyarylate, and/or polybenzimidazole, polyesters comprising polycarbonates, polyurethane, polyimide, polyhydrazide, phenolic resins, polysilane, polysiloxane, polycarbodiimide, polyimine, azo polymers, polysulfide, and/or polysulfone, polysaccharides, cellulosic polymers, starch, derivatives of starch and cellulose, homopolymers, and/or copolymers.

25. The microstructured catalytic substrate of claim 21 wherein the polymerizable oxide precursor is selected from the group of silicates, silanes, and organosilanes, including polysiloxanes, polycarbosilanes, organosilazanes, polysilazanes, alkoxide-derived siloxanes, alkyl-cyclosiloxanes, alkyl-alkoxy-silanes, poly-alkyl-siloxanes, amino-alkyl-alkoxy-silanes, and alkyl-orthosilicates, tetraethylorthosilicate, organotitanates, organic aluminoxy compounds, organozirconates, and organomagnesium compounds.

26. The microstructured catalytic substrate of claim 21 wherein the catalytic metal precursor is bimetallic and comprises Co—Mo, Co—W, Co—Cr, Co—Nb, Co—Re, Ni—Mo, Ni—W, Ni—Cr, Ni—Nb, Ni—Re, Ru—Mo, Ru—W, Ru—Cr, Ru—Nb, Ru—Re, Rh—Mo, Rh—W, Rh—Cr, Rh—Nb, Rh—Re, Pd—Mo, Pd—W, Pd—Cr, Pd—Nb, Pd—Re, Ir—Mo Ir—W, Ir—Cr, Ir—Nb, Ir—Re, Fe—Mo, Fe—W, Fe—Cr, Fe—Nb, Fe—Re, Pt—Mo, Pt—W, Pt—Cr, Pt—Nb, or Pt—Re.

27. The microstructured catalytic substrate of claim 21 wherein the carbon-containing gas comprises at least one of a saturated or unsaturated aliphatic hydrocarbon, carbon monoxide, and oxygenated hydrocarbon, aromatic hydrocarbons, and/or mixtures of the above.
